(19) United States
(12) Patent Application Publication
(10) Pub. No.: US 2006/0059365 A1
(43) Pub. Date: Mar. 16, 2006

(54) Facility security with optical cards

(75) Inventor: W. Jack Harper, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/076,410

(22) Filed: Mar. 8, 2005

Related U.S. Application Data
(63) Continuation-in-part of application No. 10/726,971, filed on Dec. 2, 2003.
Application No. 10/726,971 is a continuation-in-part of application No. 09/454,717, filed on Dec. 6, 1999, now Pat. No. 6,775,774.

(51) Int. Cl. H04K 1/00; H04L 9/00

(52) U.S. Cl. 713/186

(57) ABSTRACT

Security of a distribution facility is maintained. Authorization information is read from a security optical card or other technology card presented by a person attempting to engage in a restricted activity within the distribution facility or gain access to the facility. An identity of the person is verified as corresponding to an identity of a cardholder to whom the security optical card was issued. It is confirmed that engaging in the restricted activity or gaining access by the cardholder is permitted in accordance with the authorization information. The person is then permitted to engage in the restricted activity or is given access.

### CROSS-REFERENCE TO RELATED APPLICATIONS

This application is a continuation-in-part of U.S. Pat. Ser. No. 10/726,971, entitled “OPTICAL CARD BASED SYSTEM FOR INDIVIDUALIZED TRACKING AND RECORD KEEPING,” filed Dec. 2, 2003 by W. Jack Harper, which is a continuation of U.S. Pat. No. 6,775,774, entitled “OPTICAL CARD BASED SYSTEM FOR INDIVIDUALIZED TRACKING AND RECORD KEEPING,” filed Dec. 6, 1999 by Jack Harper, the entire disclosures of both of which are incorporated herein by reference for all purposes.

### BACKGROUND OF THE INVENTION

This application relates generally to optical cards. More specifically, this application relates to the use of optical cards and other technology cards for providing security at facilities.

Recent years have seen a significant increase in recognizing the need to maintain security at a variety of facilities. This was highlighted dramatically with the set of terrorist attacks on the United States in September 2001, and has been reinforced with a variety of other incidents that have taken place around the globe. While the incidents in September 2001 used aircraft in perpetuating terrorist acts, their scale has prompted both governments and the general public to be concerned with other large-scale systems that might be subject to infiltration and abuse by terrorists. This includes, for example, power-generation facilities, particularly nuclear power-generation facilities, water-distribution facilities, food-distribution facilities, and a variety of other distribution facilities. Some of these distribution facilities, such as water- and food-distribution facilities have the potential to be used to distribute biological or chemical contaminants into public distribution systems, thereby raising the specter of widespread biological or chemical attacks. Concern surrounding such capabilities has been heightened since mail-distribution facilities were used in the United States to distribute anthrax, resulting in several deaths and widely distributed fear among citizens. This was coupled with significant economic impacts as mail-distribution facilities were shut down for extended periods of time for inspection and decontamination, and by the implementation of inspection procedures for several identified potential targets for other attacks.

A consequence of these events is the identification of a general need in the art for mechanisms to secure facilities, particularly facilities that might be used for coordinated terrorist attacks.

### BRIEF SUMMARY OF THE INVENTION

Embodiments of the invention thus provide methods for maintaining security of a distribution facility. Authorization information is read from a security optical card presented by a person attempting to engage in a restricted activity within the distribution facility. An identity of the person is verified as corresponding to an identity of a cardholder to whom the security optical card was issued. It is confirmed that engaging in the restricted activity by the cardholder is permitted in accordance with the authorization information. The person is then permitted to engage in the restricted activity.

In some such embodiments, the identity of the person is verified by reading first biometric information from the security optical card that identifies the cardholder and measuring second biometric information from the person, so that the first and second biometric information may be compared. In one embodiment, a record is written to the security optical card of the person engaging in the restricted activity. Examples of restricted activities include accessing a restricted area within the distribution facility, accessing a restricted product within the distribution facility, and performing a restricted function within the distribution facility. In one embodiment, medical information relating to the cardholder is also read from the security optical card and verified to be consistent with medical restrictions placed on engaging in the restricted activity. In another embodiment, audit-history information is read from the security optical card identifying past engagements in restricted activities within the distribution facility. A combination of the audit-history information with the engagement in the restricted activity is evaluated to assess a risk of attempt by the person to perform a suspicious series of restricted activities. It is then confirmed that the risk is less than a predetermined threshold level.

In other embodiments of the invention, a method is also provided for maintaining security of a distribution facility. Authorization information is read from a security optical card presented by a person attempting to engage in a restricted activity within the distribution facility. First biometric information is read from the security optical card that identifies a cardholder to whom the security optical card was issued. Second biometric information is measured from the person. The first and second biometric information are compared. It is determined that the person is not authorized to engage in the restricted activity because the first and second biometric information are not consistent with being drawn from the same individual or the authorization information is not consistent with the cardholder engaging in the restricted activity. Accordingly, the person is denied to engage in the restricted activity. A record of denying the person to engage in the restricted activity is written to the security optical card.

In one such embodiment, the first and second biometric information are not consistent with being drawn from the same individual, and the record written to the security optical card includes the second biometric information.

In further embodiments of the invention, a method is provided for maintaining security of a water-treatment facility. Authorization information is read from a security optical card presented by a person attempting to engage in a restricted activity within the water-treatment facility. First biometric information is read from the security optical card that identifies a cardholder to whom the security optical card was issued. Second biometric information is measured from the person. The first and second biometric information are compared to verify an identity of the person corresponds to an identity of the cardholder. It is confirmed that engaging in the restricted activity by the cardholder is permitted in accordance with the authorization information. The person is then permitted to engage in the restricted activity and a record of the person engaging in the restricted activity is written to the security optical card.

In some such embodiments, medical information related to the cardholder is also read from the security optical card and is verified to be consistent with medical restrictions placed on engaging in the restricted activity. In other such embodiments, audit-history information is read from the security card identifying past engagements in restricted activities within the water-treatment facility. A combination of the audit-history information with engagement in the restricted activity is evaluated to assess a risk of attempt by the person to perform a suspicious series of restricted activities. That the risk is less than a predetermined threshold level is confirmed.

Still other embodiments of the invention provide a security optical card comprising a laminated card having a pattern of burn holes that encode information according to a set of fields. One included field is an identification field having optically encoded information identifying a biometric of an authorized holder of the security optical card. Another included field is a certifications field having optically encoded information summarizing authorizations of the authorized holder to engage in restricted activities within a distribution facility. Another included field is an audit-history field having optically encoded information providing particulars of a plurality of past permissions provided for the authorized holder to engage in restricted activities within the distribution facility.

In some such embodiments, the audit-history field further has optically encoded information providing particulars of a past denial for the authorized holder to engage in a restricted activity within the distribution facility. The particulars of the past denial may include biometric information identifying a person who presented the security optical card to engage in the restricted activity, the biometric information being inconsistent with the biometric of the authorized holder. In one embodiment, a further included field is a medical-information field having optically encoded information summarizing medical information relating to the authorized holder. In some instances, the audit-history field provides particulars of every past permission provided for the authorized holder to engage in restricted activities within the distribution facility.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1C are illustrations of different structures for security optical cards used in different embodiments of the invention;

FIGS. 2A-2D are schematic illustrations of different embodiments of architectures that make use of the security optical cards of FIGS. 1A-1C in providing security to a facility;

FIG. 3 is a diagram providing an exemplary data structure for information maintained on a security optical card; and

FIGS. 4A-4C are flow diagrams illustrating use of the security optical cards of FIGS. 1A-1C with the architectures of FIGS. 2A-2D in different embodiments.

### DETAILED DESCRIPTION OF THE INVENTION

Embodiments of the invention provide method and system that provide and/or enhance security at distribution facilities. As used herein, a “distribution facility” is intended to refer to a structure or collection of structures used in distributing a product to different geographical locations. Examples of distribution facilities thus include water-treatment plants that distribute potable water to homes and businesses, nuclear and other power plants that distribute electrical energy to homes and businesses, food distribution facilities that irradiate and initiate shipment of foodstuffs to grocery stores and other food outlets, and the like.

Implementation of security at such distribution facilities may include restricting access to certain areas within the facility, restricting access to certain products used within the facility, restricting certain operations that may be performed, and the like. These types of restrictions are generally imposed on personnel employed at the distribution facility, with different personnel being given access to certain areas, products, operations, etc. depending on such factors as their need for such access, their general level of responsibility within the facility, whether they have passed a security check or been provided with a government security clearance, and the like. In addition, implementation of security may include ensuring that certain personnel meet certain medical standards, requiring that they have inoculations against certain specified organisms, for example.

Embodiments of the invention make use of optical-card records to implement restrictions to areas within the facility, restrictions to access of products, restrictions of operations that may be performed, and the like, and are also used to record an audit trail of activity performed by various employees. These capabilities may be coupled with the use of surveillance devices such as video cameras, audio recording devices, and the like. The combination thus provides methods and systems that permit accurate and comprehensive records to be maintained of activities that take place within the facility and to impose restrictive controls that limit how those activities take place. In some alternative embodiments, other types of technology cards may be used, such as smart cards or RFID cards that have no optical component.

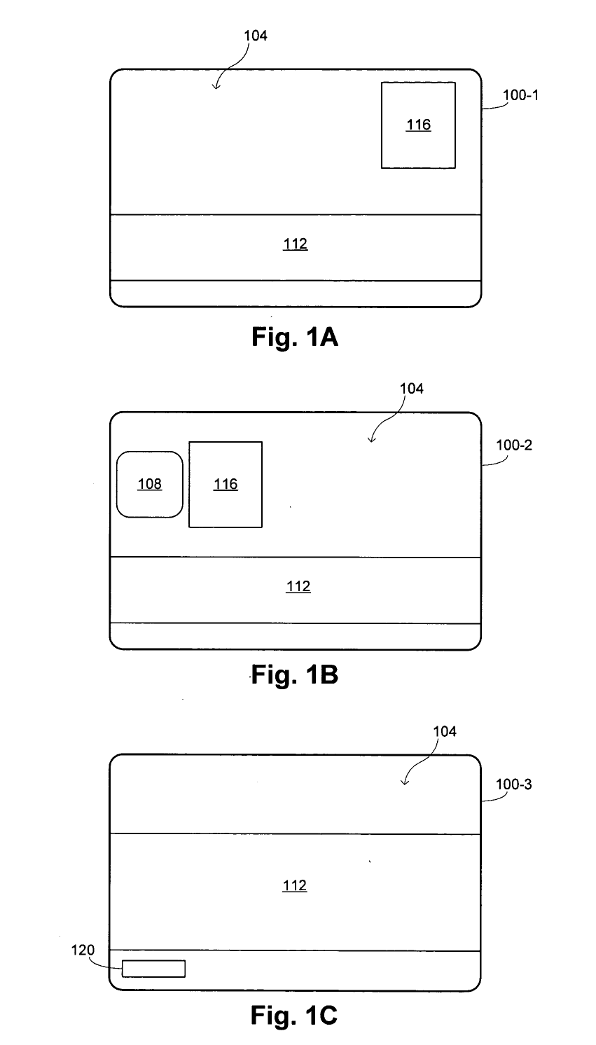

Embodiments of the invention may function well with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 100-1000 times the amount of information as a typical smart card. Unlike smart cards, optical cards are also impervious to electromagnetic fields, including static electricity, and they are not damaged by normal bending and flexing.

These properties of optical cards, particularly their large storage capacity, makes it possible for complete security auditing information to be stored, in addition to diverse identification, medical, and other information. For example, a single optical card may store fingerprint biometrics for all ten fingers, iris biometrics for both eyes, hand-geometry specifications for both hands, and a high-resolution color photograph of a cardholder while still using far less than 1% of its capacity. The large storage capacity also allows information for essentially every use of the card to be written to the card and thereby provide a permanent detailed audit trail.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser bums a small hole, about 2 μm in diameter, in the material; the hole can be sensed by a low-power laser during a read cycle. The presence or absence of the bum spot defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. Embodiments in which the optical card includes a magnetic stripe may usefully provide compatibility with other security systems, perhaps including older legacy security systems that use such functionality. The printed area 104 could include any type of information, such as information identifying the cardholder so that, in combination with the photograph 116, it acts as a useful aid in authenticating a cardholder's identity. The printed area 104 could also include information identifying the employment category of the cardholder, a security classification of the cardholder, and the like. The optical storage area 112 holds digitized information, and may comprise a plurality of individual sections as described below that may be designated individually by an addressing system.

The information on optical cards is generally visible to readers, and may in some instances be encrypted to prevent unauthorized access. A description of encryption and other security techniques that may be used with the optical cards is provided in copending, commonly assigned U.S. Pat. Appl. No. 60/543,595, entitled “CRYPTOGRAPHICALLY SECURE TRANSACTIONS WITH OPTICAL CARDS,” filed Feb. 10, 2004 by Jack Harper, the entire disclosure of which is incorporated herein by reference for all purposes. Information on the security optical card 100 may also sometimes be authenticated. Authenticated information can be verified as being unmodified by any number of parties in a trust chain. By using certificates, the authenticity of the stored information can be confirmed by a number of parties. Various techniques using a variety of different algorithms known to those of skill in the art may be used to confirm authenticity. In some cases, the authenticity of an optical card may be confirmed from a wide-area network, but in other cases authenticity can be confirmed without contacting other parties.

An example of use of such a chain of trust is a mechanism that covers a situation where biometrics are to be used but are not obtainable for a particular employee cardholder when the card is issued. It is known that for certain biometric measurements, there is often a small but finite segment of the population from which biometric measurements cannot be obtained. In such an embodiment, a local supervisor of a distribution facility may be authenticated to the issuing optical-card machine with his/her biometrics on his/her security optical card, and the biometric requirement overridden. The override event is then recorded both on the employee's card and on the supervisor's card. It is generally expected that such an override capability will only be provided for gaining access to limited areas or for performing limited functions, and that there will be other more sensitive areas or functionality that remain inaccessible without confirmation of the employee's biometrics directly.

Another embodiment of a security optical card 100-2 is illustrated in FIG. 1B. This embodiment adds electronics 108 to the optical card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108. In some alternative embodiments, a smart-card structure might be used without any optical component at all.

A further embodiment of a security optical card 100-3 is shown in FIG. 1C. To illustrate that different embodiments may accommodate different sizes of optical storage areas, this embodiment uses a larger optical storage area 112 than the embodiments of FIGS. 1A or 1B. In addition, a radio-frequency identification (“RFID”) tag 120 that can be read by proximity readers may be included. In some alternative embodiments, an RFID card structure might be used without any optical component at all.

The security optical cards illustrated in FIGS. 1A-1C may be used in a variety of different network structures, some of which do not require large, complex support systems. For example, in some network structures, a plurality of optical security devices are interconnected solely by optical cards. In such cases, audit information may be stored only on the optical cards carried by employee cardholders, rather than being stored in any central or local database. Software and other informational updates to the optical security devices may be communicated with optical cards containing information for those purposes. A detailed description of an optical reader that may be comprised by an optical security device and that may thereby be used in embodiments of the invention is provided in commonly assigned U.S. Pat. No. 6,77,774, entitled “OPTICAL CARD BASED SYSTEM FOR INDIVIDUALIZED TRACKING AND RECORD KEEPING,” filed Dec. 6, 1999 by Jack Harper, the entire disclosure of which is incorporated herein by reference for all purposes. Generally, the optical security device may include a card slot adapted to accept an optical card so that data may be read from or written to the optical card, a display screen for displaying data about the optical card or transaction being executed, and a printer for generating hard copy.

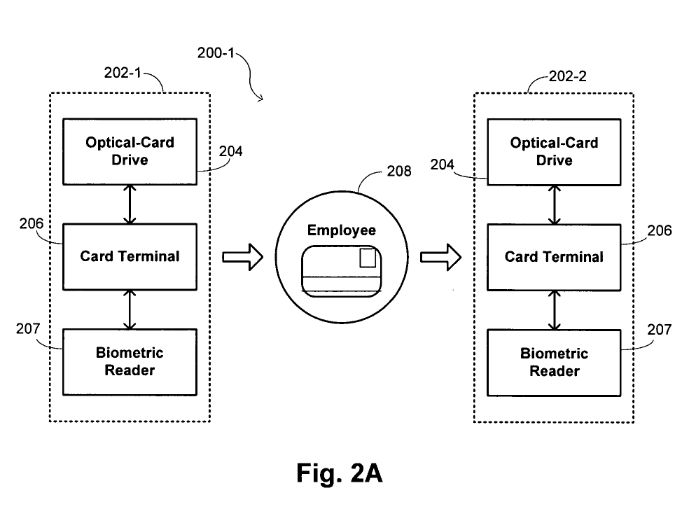

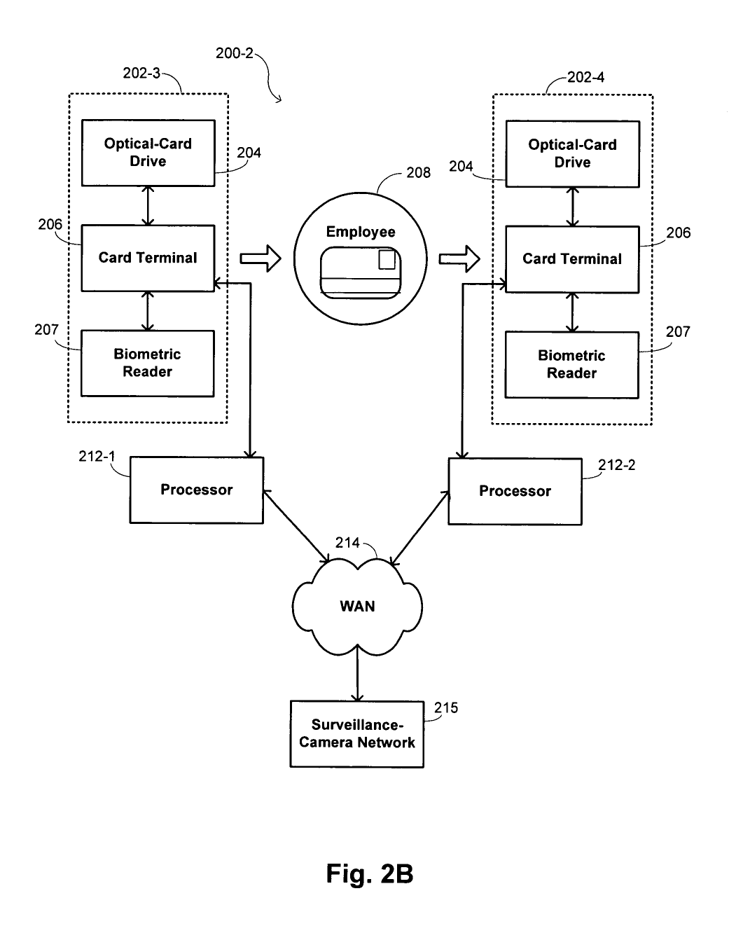

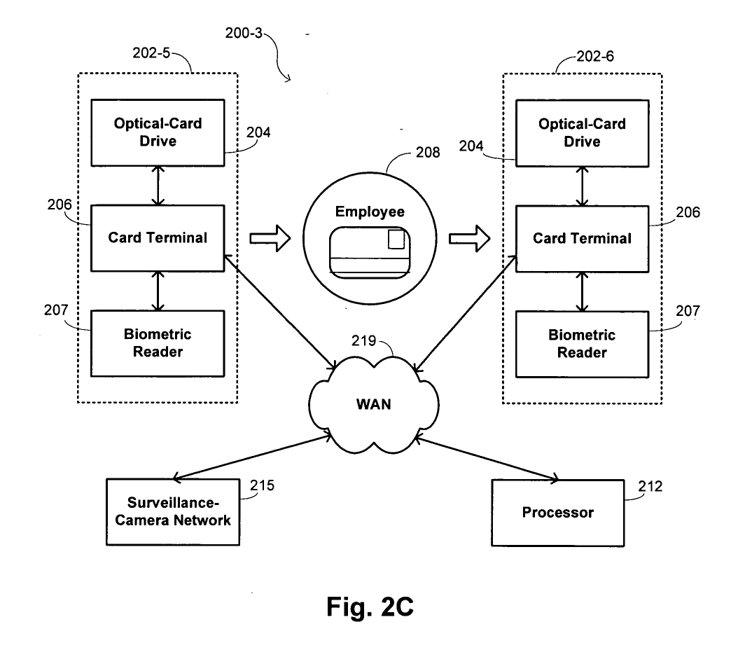

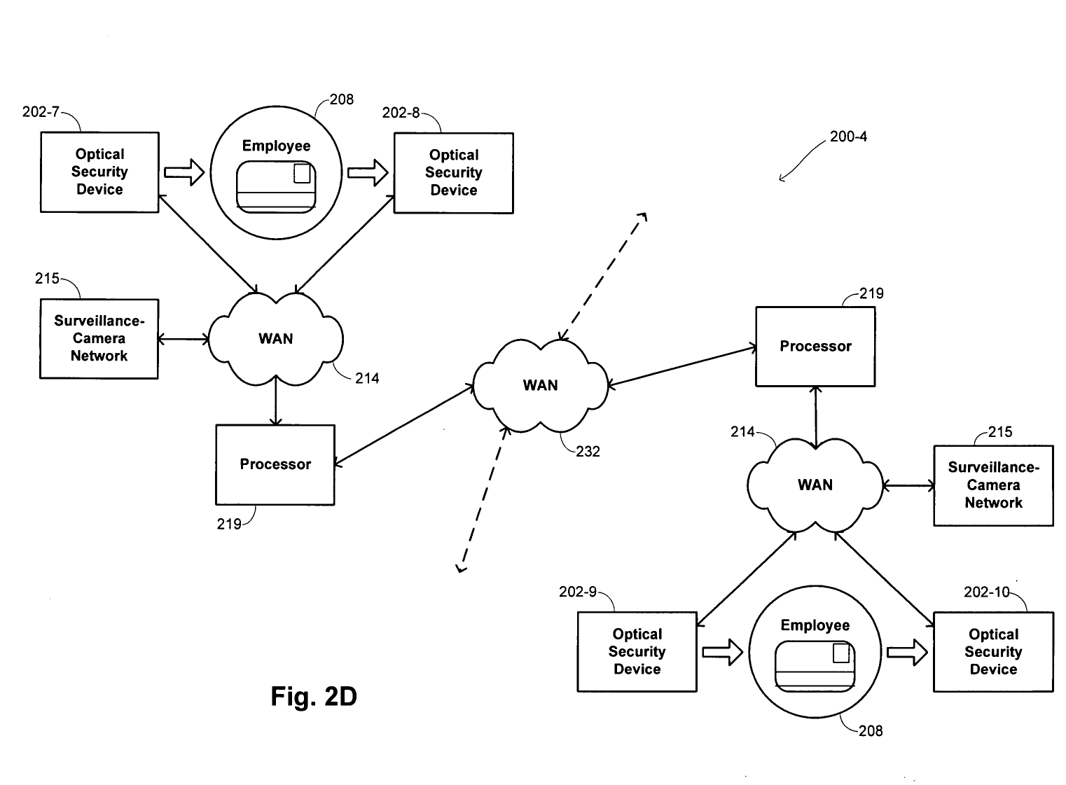

One network structure 200-1 that may be used in providing security to a distribution facility with the security optical cards is illustrated in FIG. 2A. In this figure, each optical security device 202 is shown to comprise an optical-card drive 204, a card terminal 206, and a biometric reader 207. These components may be provided as separate components of the optical security device 202 or may be integrated in different embodiments. The optical-card drive 204 is configured for reading from and writing to optical cards, while the card terminal comprises a computational device used in determining whether to permit or restrict access by employees to certain areas of the distribution facility, to permit or restrict access by employees to certain products used within the distribution facility, to permit or restrict employees from performing certain functions within the distribution facility, or the like. While the drawing in FIG. 2A shows two optical security devices 202 for illustrative purposes, there will generally be a larger number of optical security devices 202 spread throughout the distribution facility at positions used to control employee access. Each time an employee 208 attempts to gain access to a controlled area, to gain access to a controlled product, to perform a controlled function, etc., a determination is made whether to permit or restrict the attempt and to record information about the attempt on the card. This information is then accessible by a subsequent optical security device 202 to which the card is presented in a similar interaction.

The biometric reader 207 is coupled with the card terminal 206 so that the kinds of determinations described above may be effected in part by collecting biometric information from an employee presenting a security optical card. The biometric readers may be configured to read any of a variety of different types of biometric measurements, such as fingerprint measurements, iris-structure measurements, facial-geometry measurements, hand-geometry measurements, and the like. In some instances, the biometric readers may be configured to read a plurality of distinct types of biometric measurements, using known data-fusion techniques to combine the information from those measurements and thereby improve the accuracy of identity determinations made from the biometric measurements.

In some embodiments, the network structure may permit additional communications between optical security devices 202 to occur by electronic or other mechanisms different from the distribution of the security optical cards themselves. Such a network structure 200-2 is illustrated in FIG. 2B, in which some optical security devices 202-3 may be provided in communication with a first processor 212-1 and other optical security devices 202-4 may be provided in communication with a second processor 212-2. For example, the processors 212 might be located in different buildings or in different parts of a building comprised by a distribution facility. In other instances, the processors 212 may even be comprised by different distribution facilities. In some such cases, each processor 212 may be in communication with a plurality of optical security devices 202 that define a subnetwork distinct from another subnetwork having a plurality of optical security devices 202 in communication with a different processor 212. In such embodiments, each subnetwork might be interconnected only with security optical cards, with the subnetworks being interconnected through a wide-area network 214 that permits interaction between the otherwise distinct subnetworks. In other embodiments, every optical security device 202 may be interfaced with a different processor 212, the wide-area network 214 thereby providing an alterative mechanism for interconnecting the network that does not rely on the distribution of security optical cards. Connections between the processors 212 and wide-area network 214 may comprise wired connections, fiber-optic connections, wireless connections, among other types of connections known to those of skill in the art.

Furthermore, the network may also include other security devices, particularly devices that are adapted to collect surveillance information. FIG. 2B provides the example of a network of surveillance cameras 215 that might be used to monitor controlled areas and other parts of the distribution facility where controlled products are stored or controlled functions are performed. The use of this example is not intended to be limiting since other surveillance devices may be used in other embodiments, including infrared sensors, sound-recording devices, thermal sensors, motion detectors, and the like. Information collected by these other security devices may be correlated with information collected by the optical security devices 202 by integrating the additional security devices into the network through the wide-area network 214 as shown in FIG. 2B or by connecting them at other points in the network, such as by providing them in communication with one or more of the processors 212. In some instances, such additional security devices, in the form of digital cameras, digital audio devices, thermal sensors, motion detectors, or the like, may be connected directly with, or integrated with, the optical security devices 202. Such coupling with the optical security devices 202 advantageously reproduces the distribution of the optical security devices at sensitive areas within the distribution facility for the additional security devices.

An alternative networking configuration that permits interconnection between optical security devices 202 both through security optical cards and through other mechanisms is illustrated in FIG. 2C. With this network structure 200-3, each of multiple optical security devices 202 is provided in communication with a single processor 212 through a wide-area network 219. Such a configuration may be especially suitable for a network associated with a fairly localized distribution facility so that operations of the optical security devices 202 may be handled consistently by the single processor 212. Like the embodiment shown in FIG. 2B, the wide-area network 219 may also be provided in communication with other security devices such as surveillance devices. FIG. 2C shows the specific example of a network of surveillance cameras 215, bat as discussed in connection with FIG. 2B may comprise a variety of other types of devices. These devices may be distributed throughout the distribution facility in substantially the same way as the optical security devices 202 or may be distributed differently, depending on the specific needs and structure of the distribution facility.

In still other embodiments, the arrangement of FIG. 2C may be extended to allow interfacing multiple optical security device subnetworks that are otherwise distinct. In FIG. 2D, the network architecture 200-4 comprises multiple subnetworks that each correspond to the network 200-3 of FIG. 2C, including optical security devices 202 in communication with a single processor 219 through a wide-area network 214. These subnetworks are themselves interconnected through a wide-area network 232 that allows communications to take place between the processors 219 associated with each of the subnetworks. Although not shown explicitly in FIG. 2D, other security devices may additionally be included as part of each subnetwork as described in detail above. While the architecture 200-4 is shown explicitly for two subnetworks, it may more generally comprise any number of subnetworks linked through the wide-area network 232 as indicated schematically with the dashed connection lines. This type of configuration lends itself particularly to arrangements in which the distribution facility comprises a plurality of distribution facilities. For example, each subnetwork might be used in providing security to a separate municipal water-treatment facility, with the interconnection of the separate subnetworks enabling security issues to be addressed for water-treatment facilities distributed over an entire county, state, or country. Other types of arrangements that may especially benefit from the configuration of FIG. 2D occur when some of the subnetworks correspond to different distribution facilities. For instance, a county may have several water-treatment facilities, a nuclear power plant, a meat-packing plant, and a pharmaceutical distribution center within its boundaries. Each subnetwork may thus be used in providing and evaluating security at one of these facilities, with wide-area network 232 permitting a more integrated monitoring. In some instances, all of the distribution facilities will be public facilities so that monitoring their security is clearly a state function. This example, however, provides an illustration where some of the facilities may be private facilities, in which case their integration with public monitoring may be a result of suitable compliance legislation.

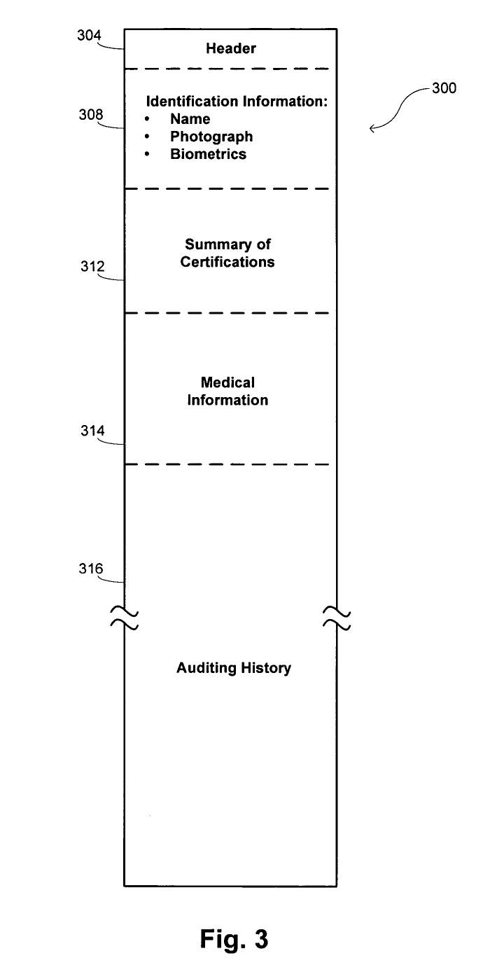

The security optical cards used by any of the architectures described in connection with FIGS. 2A-2D may use any of a variety of different data structures to store information used in limiting access within a distribution facility and/or maintaining an audit trail of employee activity. One such data structure 300 is shown explicitly in FIG. 3 for illustrative purposes. In this embodiment, the security-optical-card data structure 300 comprises a header 304, fields 308 for identification information, fields 312 for summarizing certifications that have been approved for the cardholder, field 314 for summarizing medical information regarding the cardholder, and field 316 for maintaining an audit history of some or all uses of the security optical card.

The header 304 identifies the data structure 300 and includes a description of the data structure, specifying such characteristics as size, encryption format, certificate format, version information, and the like.

The identification fields 308 include optically encoded representations of such identification information as a name of the cardholder, a photograph of the cardholder, and biometrics unique to the cardholder, such as fingerprints, retinal scans, hand-geometry specifications, and the like. The optically encoded photograph is rendered in digital form, as opposed to a visual rendering such as might be done in ink. This identification information may be used in confirming identity to authorize or deny access to areas, access to products, and ability to perform controlled functions.

The certifications fields 312 generally contain an overview of specific certifications that have been provided for the employee cardholder. One class of certifications comprise area certifications, which define controlled areas within a distribution facility that the cardholder is authorized to enter. Such designations may be provided on an area-by-area basis, in which case the area certifications will identify every area that the employee is permitted to enter and/or every area that the employee is not permitted to enter. Alternatively, an area-classification scheme may be used in which each employee is authorized to access areas according to the classification. For instance, areas could be identified as having security levels A, B, C, D, and E, with low-level A areas being general common areas within the distribution facility that are accessible to any employee of the facility, and E areas being highly sensitive areas. For instance, in a nuclear power plant, A areas might include lunch rooms, secretarial areas, and the like, while E areas might include reactor areas, etc. An employee with, say C-level access, would be permitted to access A, B, and C areas, but would be prohibited from accessing D and E areas. The use of a classification system advantageously permits access levels to be changed relatively simply to respond to changed circumstances by changing the designated security level for a particular area. Furthermore, such a technique may also make use of overrides that permit a particular employee access to a specific area notwithstanding his otherwise insufficient access level and/or deny a particular employee access to a specific area even though his base access level would ordinarily permit access.

Another class of certifications includes product certifications, which define products within the distribution facility that the employee is permitted to access. Again, such designations may be provided on a product-by-product basis, or may use a classification system to define different levels of product access. Many distribution facilities make use of products that may be hazardous or warranting control for other reasons. For example, a water-treatment facility may use concentrated chlorine, which is corrosive to biological tissues and to many other substances. Chemical distributors may frequently maintain substances that are dangerous to human life and/or environmentally dangerous. Access to such substances is thus appropriately controlled. As a further example, a pharmaceutical distributor may maintain stores of various drugs that are subject to governmental control so that some mechanism for complying with the governmental controls is needed.

Another class of certifications includes function certifications, which define functions or other operations that employees are permitted to perform. Qualification for performing such functions may be dependent on such factors as educational level of the employee, whether the employee has been trained in performing the function safely, what potential risks are present if the function is performed incorrectly, and the like. For instance, some employees of a water-treatment facility may be authorized to determine concentrations of halogens and other chemicals to be used in treating water based on the results of sample testing. Such functions will generally be limited only to those with sufficient educational background, experience, authority within the facility, and perhaps having had satisfactory background checks cleared. Again, the function certifications may be established on a completely individual basis or may use a classification system that is perhaps subject to overrides to tailor the specific functional access by the employee.

The medical-information fields 314 may be of greater relevance for some types of distribution facilities than they are for other types. Such medical information may include such data as whether the employee has received certain inoculations, which is particularly valuable in distribution facilities like water-treatment plants where there is a risk of infectious agents entering the product to be distributed. In other instances, medical information might be used in performing risk assessments for the benefit of the employee. For instance, if certain medical conditions or combinations of conditions were found to be aggravated by exposure to certain materials, employees with those conditions might automatically be prevented from entering areas or using products where there was an increased risk of exposure.

A partial or complete record of attempts to access controlled areas, products, or functions may be stored in the auditing history field 316. It is generally expected that a complete record is preferred since it may not be known in advance which information will be of most use in performing an audit. The auditing history thus specifies such information as date and time when access was attempted, where access was attempted such as may be specified by a code identifying which optical security device 202 was used in the attempt, what biometric information may have been supplied as part of the access attempt, what the result of the access attempt was, and perhaps a reason that access was denied or granted. For instance, if access is denied during a particular attempt, a code may be written to the security optical card that indicates the required access level was greater than the cardholder had at the time of the attempt. Or, a code might be written to the security optical card indicating that even though the required access level was greater than the cardholder had at the time, an override code has existed to permit access by that cardholder at that time.

The usefulness of an auditing history is evident in some embodiments where patterns within the auditing history may be used in changing access parameters. For example, a particular employee may ordinarily have access to a number of controlled products, areas, and functions, but it may have been determined that a particular sequence of accesses within a particular timeframe indicates that there is a high risk that they form part of an improper activity. If the risk level reaches a sufficiently high level that this is the case, access to an area, product, or function might be changed to account for the fact that even with the access levels provided to the employee, the pattern of behavior is suspect.

The specific fields discussed above are not intended to be exhaustive. Still other information may be stored within the data structure of the optical card in specific embodiments, such as may be desired for specific environments and applications.

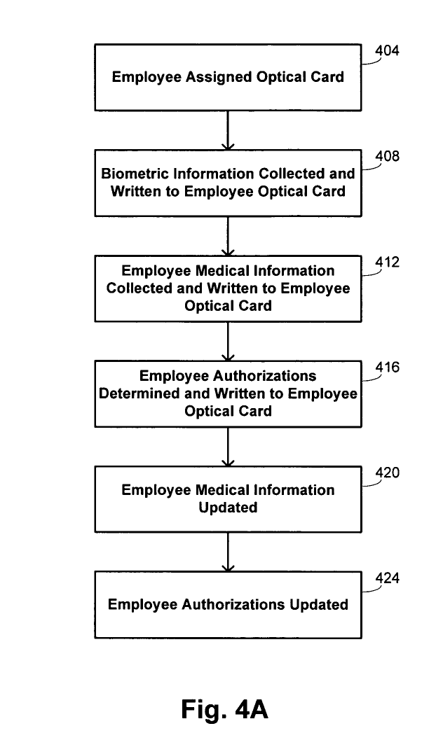

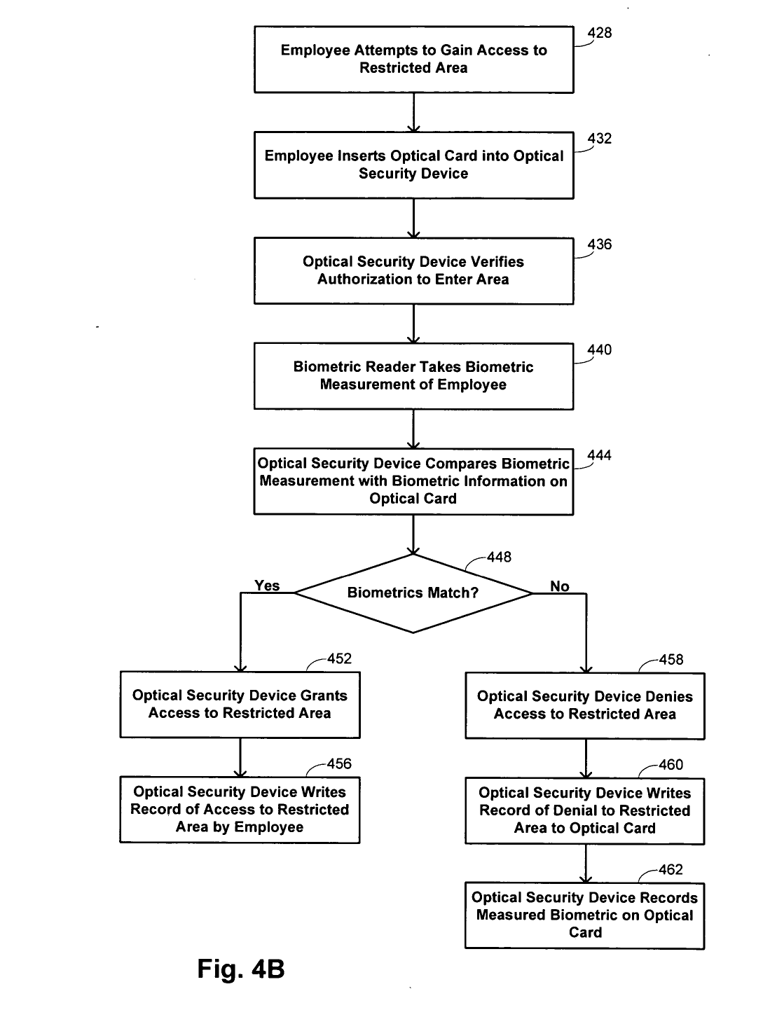

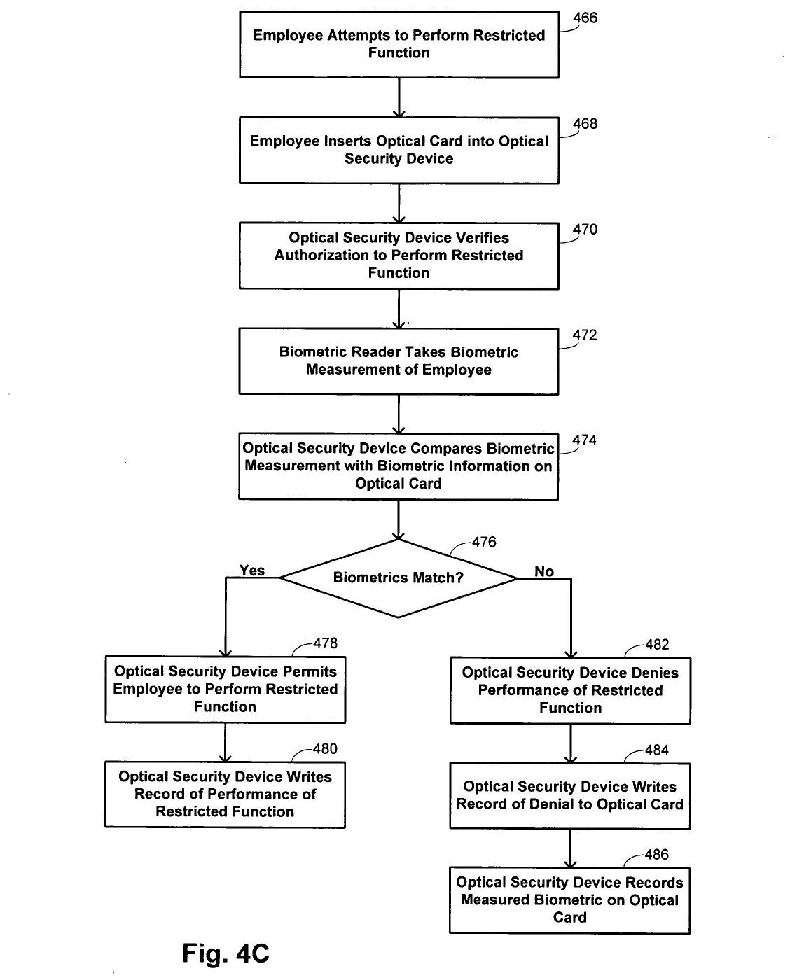

An overview is given in FIGS. 4A-4C of how the system described above may be used in some embodiments to provide or enhance security at a distribution facility. These illustrations provide examples of how optical cards may be used in providing or enhancing security within the architectures of FIGS. 2A-2D and with the exemplary data structure shown in FIG. 3, but they are not intended to be exhaustive. Methods for executing a variety of other security functions using security optical cards will be evident to those of skill in the art after considering these illustrations.

FIG. 4A begins with an illustration of how a security optical card for an employee of a distribution facility may be initialized. At block 404, the employee is assigned a particular optical card. Biometric information is collected from the employee at block 408, such as by reading one or more fingerprints of the employee, taking a photograph of the employee, extracting hand-geometry measurements from the employee, extracting facial-geometry measurements from the employee, scanning the retina or iris of the employee and the like. The biometric information is written to the employee optical card in digital form in field 308 so that it may later be used n performing identifications of the employee. At block 412, employee medical information is collected and written to the card in field 314, and may comprise any of a variety of types of information used in implementing security functions as described above. The specific authorizations and certifications that have been given to that employee are written to the optical card in field 312 and may identify specific areas, products, and/or functions that are authorized for the employee, may use an access-level designation, or may use a combination of the two by assigning a default access-level designation that is subject to possible overrides.

At this point, the security optical card may be ready for use by the employee in implementing his employment functions as described in greater detail in connections with FIGS. 4B and 4C. From time to time, however, it may be necessary to update certain information on the card to reflect chances in circumstances. Such updates may generally be written using any optical-card device, although it is anticipated that most often a special personnel device will be used for updates rather than using the optical security devices distributed about the distribution facility. For example, as indicated at block 420, the employee medical information may sometimes be updated in field 314. This may occur, for instance, when the employee has received an inoculation that may be then permit the employee to have greater access or when there has been a change in the general health of the employee that may affect the extent of his access. Similarly, as indicated at block 424, the employee authorizations may sometimes be updated in field 312 to reflect organizational changes, a promotion or demotion of the employee, a reevaluation of risk levels of certain activities, and the like. Still other fields may be updated in some cases, such as where an employee changes her name as a result of marriage or when it is desirable to update photographs of the employee, or to change other identification information in field 308.

Once an employee is in possession of his security optical card, he may proceed to perform his employment functions, which will involve occasional interaction with the optical security devices 202 positioned throughout the distribution facility in controlling access. For instance, when access to a particular area is to be controlled, the area may be accessible through one or more doors, the locks on which are controlled by one of the optical security devices. To attempt to gain access to the restricted area, as indicated at block 428, the employee inserts his security optical card into the optical-card reader comprised by the optical security device at block 432. The optical-card reader reads the information regarding certifications for the proper holder of the presented optical card from field 312 to verify that the proper holder is authorized to enter the area at block 436. Identity of the person presenting the security optical card is checked by the biometric reader comprised by the optical security device measuring a biometric of the employee at block 440. The optical-card reader also retrieves the biometric information for the authorized employee from field 308 so that a comparison of the measured biometric and stored biometric may be made at block 444.

If the biometrics match, as checked at block 448, the employee will generally be granted access to the area at block 452, such as by the optical security device disengaging the locks for a sufficient period of time for the employee to enter the area. Upon deciding to grant access, the optical security device writes a record of the attempted access, and that is was granted, to the auditing-history field 316 at block 456. If the biometrics fail to match, the optical security device instead denies access to the employee at block 458, and may provide some kind of indicator to the employee that access has been denied, such as in the form of a red light or a text message. The optical security device writes a record of the denial to the auditing-history field 316 on the optical card at block 460 to record the attempted access and denial. In addition, especially in those cases where the reason for denying access is a failure of biometric measurements to match, the optical security device may write a record of the measured biometric to the auditing-history field 316 at block 462. Such a record may later be useful in determining who was in possession of the security optical card at the time of the unsuccessful access attempt.

The method may use still other criteria in determining whether to grant access to an area. For example, as previously mentioned, past activity may be read from the auditing-history field 316 of the employee's security card by the optical security device and analyzed for the presence of patterns that have been identified as suspicious. For instance, it may be known that within a nuclear power plant, accessing radioactive-material stores is rarely done and, if done, is never immediately followed by accessing certain areas within the facility where release of radioactive materials might be highly dangerous. If such a sequence is followed, access to the area might be denied notwithstanding the security level of the employee cardholder.

Methods similar to that outlined in FIG. 4B may be used in exercising other types of security controls within a distribution facility. For example, FIG. 4C provides a flow diagram that illustrates how control may be maintained when an employee attempts to perform a particular finction, such as changing chemical levels provided to water in a water-treatment facility or attempting to access plutonium stores in a nuclear power plant. In attempting to perform the restricted function as indicated at block 466, the employee inserts his security optical card into the security optical device that maintains control of the restricted function at block 468. The optical security device verifies the employee's authorization to perform the restricted function by reading the appropriate certification from the certification-summary field 312. If authorized, the optical security device verifies the employee's identity by taking a biometric measurement of the employee at block 472 and comparing that measured biometric with the biometric information stored in field 308 of the security optical card.

If the biometrics match, the employee is permitted to perform the restricted function at block 478 and the optical security device writes a record of the performance of the restricted function to the auditing-history field 316 at block 480. If the biometrics fail to match, performance of the restricted function is denied at block 482 and a record of the denial written to the optical card at block 484, perhaps including a record of the measured biometric at block 486 to permit later identification of who was in possession of the security optical card at the time of attempting the restricted function. Similar to the description of FIG. 4C, this method may sometimes use additional criteria in deciding whether to permit performance of the restricted function, including using information in the auditing-history field 316 to perform a risk assessment in identifying unusual or suspicious activity that warrants an override of the normal authorizations.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for maintaining security of a distribution facility, the method comprising:
reading authorization information from a security optical card presented by a person attempting to engage in a restricted activity within the distribution facility;
verifying an identity of the person as corresponding to an identity of a cardholder to whom the security optical card was issued;
confirming that engaging in the restricted activity by the cardholder is permitted in accordance with the authorization information; and
permitting the person to engage in the restricted activity.

2. The method recited in claim 1 wherein verifying the identity of the person comprises:
reading first biometric information from the security optical card that identifies the cardholder;
measuring second biometric information from the person; and
comparing the first and second biometric information.

3. The method recited in claim 1 further comprising writing a record of the person engaging in the restricted activity to the security optical card.

4. The method recited in claim 1 wherein the restricted activity comprises accessing a restricted area within the distribution facility.

5. The method recited in claim 1 wherein the restricted activity comprises accessing a restricted product within the distribution facility.

6. The method recited in claim 1 wherein the restricted activity comprises performing a restricted function within the distribution facility.

7. The method recited in claim 1 further comprising:
reading medical information relating to the cardholder from the security optical card; and
verifying that the medical information is consistent with medical restrictions placed on engaging in the restricted activity.

8. The method recited in claim 1 wherein the distribution facility comprises a water-treatment facility.

9. The method recited in claim 1 further comprising:
reading audit-history information from the security optical card identifying past engagements in restricted activities within the distribution facility;
evaluating a combination of the audit-history information with engagement in the restricted activity to assess a risk of attempt by the person to perform a suspicious series of restricted activities; and
confirming that the risk is less than a predetermined threshold level.

10. A method for maintaining security of a distribution facility, the method comprising:
reading authorization information from a security optical card presented by a person attempting to engage in a restricted activity within the distribution facility;
reading first biometric information from the security optical card that identifies a cardholder to whom the security optical card was issued;
measuring second biometric information from the person;
comparing the first and second biometric information;
determining that the person is not authorized to engage in the restricted activity because the first and second biometric information are not consistent with being drawn from the same individual or the authorization information is not consistent with the cardholder engaging in the restricted activity; and
denying the person to engage in the restricted activity; and
writing a record of denying the person to engage in the restricted activity to the security optical card.

11. The method recited in claim 10 wherein:
the first and second biometric information are not consistent with being drawn from the same individual; and
writing the record comprises writing the second biometric information to the security optical card.

12. A method for maintaining security of a water-treatment facility, the method comprising:
reading authorization information from a security optical card presented by a person attempting to engage in a restricted activity within the water-treatment facility;
reading first biometric information from the security optical card that identifies a cardholder to whom the security optical card was issued;
measuring second biometric information from the person;
comparing the first and second biometric information to verify an identity of the person corresponds to an identity of the cardholder;
confirming that engaging in the restricted activity by the cardholder is permitted in accordance with the authorization information;
permitting the person to engage in the restricted activity; and
writing a record of the person engaging in the restricted activity to the security optical card.

13. The method recited in claim 12 further comprising:
reading medical information relating to the cardholder from the security optical card; and
verifying that the medical information is consistent with medical restrictions placed on engaging in the restricted activity.

14. The method recited in claim 12 further comprising:
reading audit-history information from the security optical card identifying past engagements in restricted activities within the water-treatment facility;
evaluating a combination of the audit-history information with engagement in the restricted activity to assess a risk of attempt by the person to perform a suspicious series of restricted activities; and
confirming that the risk is less than a predetermined threshold level.

15. A security optical card comprising a laminated card having a pattern of burn holes that encode information according to a set of fields, the set of fields including:
an identification field having optically encoded information identifying a biometric of an authorized holder of the security optical card;
a certifications field having optically encoded information summarizing authorizations of the authorized holder to engage in restricted activities within a distribution facility; and
an audit-history field having optically encoded information providing particulars of a plurality of past permissions provided for the authorized holder to engage in restricted activities within the distribution facility.

16. The security optical card recited in claim 15 wherein the audit-history field further has optically encoded information providing particulars of a past denial for the authorized holder to engage in a restricted activity within the distribution facility.

17. The security optical card recited in claim 16 wherein the particulars of the past denial include biometric information identifying a person who presented the security optical card to engage in the restricted activity, the biometric information being inconsistent with the biometric of the authorized holder.

18. The security optical card recited in claim 15 wherein the set of fields further includes a medical-information field having optically encoded information summarizing medical information relating to the authorized holder.

19. The security optical card recited in claim 15 wherein the audit-history field provides particulars of every past permission provided for the authorized holder to engage in restricted activities within the distribution facility.
